(19) United States
(12) Patent Application Publication
(10) Pub. No.: US 2025/0124307 A1
(43) Pub. Date: Apr. 17, 2025

(54) MACHINE LEARNING BASED DEFECT EXAMINATION AND RANKING FOR SEMICONDUCTOR SPECIMENS

(71) Applicant: Applied Materials Israel Ltd., Rehovot (IL)

(72) Inventors: Aviad YAHALOM, Lavon (IL); Chen RAICH, Kibutz Nir Am (IL); Karen POMERANZ, Hod Hasharon (IL); Lior KATZ, Jerusalem (IL); Marcelo BACHER, Givatayim (IL); Tamir DUHOVNY, Rehovot (IL)

(21) Appl. No.: 18/488,888

(22) Filed: Oct. 17, 2023

(51) Int. Cl. G06N 5/022

(52) U.S. Cl. CPC G06N 5/022

(57) ABSTRACT

There is provided a system and method of defect examination on a semiconductor specimen. The method comprises: obtaining an inspection dataset informative of a group of defect candidates and attributes thereof resulting from examining the specimen by an inspection tool; classifying, by a classifier, the group of defect candidates into a plurality of defect classes such that each defect candidate is associated with a respective defect class; and ranking, by a decision model, the group of defect candidates into a total order using a sorting rule. Each defect candidate is associated with a distinct ranking in the total order representative of the likelihood of the defect candidate being a defect of interest (DOI). The decision model is previously trained to learn the sorting rule pertaining to the plurality of defect classes associated with the group of defect candidates and a series of attributes in the inspection data.

### TECHNICAL FIELD

The presently disclosed subject matter relates, in general, to the field of examination of a semiconductor specimen, and more specifically, to machine learning based defect detection of the specimen.

### BACKGROUND

Current demands for high density and performance associated with ultra large-scale integration of fabricated devices require submicron features, increased transistor and circuit speeds, and improved reliability. As semiconductor processes progress, pattern dimensions such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination can be provided by using non-destructive examination tools during or after manufacture of the specimen to be examined. A variety of non-destructive examination tools includes, by way of non-limiting example, scanning electron microscopes, atomic force microscopes, optical inspection tools, etc.

Examination processes can include a plurality of examination steps. The manufacturing process of a semiconductor device can include various procedures such as etching, depositing, planarization, growth such as epitaxial growth, implantation, etc. The examination steps can be performed a multiplicity of times, for example after certain process procedures, and/or after the manufacturing of certain layers, or the like. Additionally, or alternatively, each examination step can be repeated multiple times, for example for different wafer locations, or for the same wafer locations with different examination settings.

Examination processes are used at various steps during semiconductor fabrication to detect and classify defects on specimens, as well as perform metrology related operations. Effectiveness of examination can be improved by automatization of process(es) such as, for example, defect detection, Automatic Defect Classification (ADC), Automatic Defect Review (ADR), image segmentation, automated metrology-related operations, etc.

Automated examination systems ensure that the parts manufactured meet the quality standards expected and provide useful information on adjustments that may be needed to the manufacturing tools, equipment, and/or compositions, depending on the type of defects identified.

In some cases, machine learning technologies can be used to assist the automated examination process so as to promote higher yield. For instance, supervised machine learning can be used to enable accurate and efficient solutions for automating specific examination applications based on sufficiently annotated training images.

### SUMMARY

In accordance with certain aspects of the presently disclosed subject matter, there is provided a computerized system of defect examination on a semiconductor specimen, the system comprising a processing circuitry configured to: obtain an inspection dataset informative of a group of defect candidates and attributes thereof resulting from examining the semiconductor specimen by an inspection tool; classify, by a classifier, the group of defect candidates into a plurality of defect classes such that each defect candidate is associated with a respective defect class; and rank, by a decision model, the group of defect candidates into a total order using a sorting rule, wherein each defect candidate is associated with a distinct ranking in the total order representative of the likelihood of the defect candidate being a defect of interest (DOI), wherein the decision model is previously trained to learn the sorting rule pertaining to the plurality of defect classes associated with the group of defect candidates and a series of attributes in the inspection data.

In addition to the above features, the system according to this aspect of the presently disclosed subject matter can comprise one or more of features (i) to (x) listed below, in any desired combination or permutation which is technically possible:
(i). The inspection dataset is represented as a tabular dataset.
(ii). The processing circuitry is further configured to select, from the inspection dataset, a list of defect candidates to be reviewed by a review tool, the list of defect candidates selected in accordance with a review budget of the review tool based on the distinct ranking thereof.
(iii). The processing circuitry is further configured to filter nuisances from the inspection dataset in accordance with the total order.
(iv). The processing circuitry is further configured to normalize the inspection dataset by transforming values of each given attribute of at least some of the attributes into a specific distribution, and evaluate transformation error of the transformation to determine whether to filter the given attribute from the inspection dataset, giving rise to a normalized dataset with filtered attributes, each having normalized values.
(v). The processing circuitry is further configured to partition the inspection dataset into a plurality of sub-spaces based on one or more attributes, and perform the normalizing and classifying for each sub-space. The processing circuitry is configured to rank classified defect candidates combined from the plurality of sub-spaces.
(vi). The plurality of classes comprises DOIs, nuisances, unknown, and do not care (DNC).
(vii). The classifier is previously trained based on training data derived from a subset of defect candidates that is reviewed by a review tool and has an attribute indicative of ground truth defect classes thereof.
(viii). The training data is derived by clustering the subset of defect candidates into a plurality of clusters based on values of inspection attributes of the defect candidates, and including at least the plurality of clusters of defect candidates in the training data.
(ix). The decision model is trained using a training dataset informative of a group of defect candidates and attributes thereof resulting from examining one or more semiconductor specimens by at least an inspection tool and a review tool, the attributes comprising a first attribute indicative of defect classes of the group of defect candidates generated by the classifier, the training dataset comprising a subset of defect candidates that is reviewed by the review tool and has a second attribute indicative of ground truth defect classes thereof.
(x). The decision model is trained by sorting the training dataset in accordance with the first attribute, giving rise to a sorted dataset comprising multiple subsets of defect candidates, each subset corresponding to a respective defect class of the first attribute; for each subset of defect candidates, identifying one or more attributes to be used for sorting the defect candidates within the subset so as to have a sorted subset of defect candidates in accordance with the ground truth defect classes thereof; and sorting between multiple sorted subsets to have all defect candidates in the training dataset to be sorted in accordance with the ground truth defect classes thereof.

In accordance with other aspects of the presently disclosed subject matter, there is provided a computerized method of defect examination on a semiconductor specimen, the method comprising: obtaining an inspection dataset informative of a group of defect candidates and attributes thereof resulting from examining the semiconductor specimen by an inspection tool; classifying, by a classifier, the group of defect candidates into a plurality of defect classes such that each defect candidate is associated with a respective defect class; and ranking, by a decision model, the group of defect candidates into a total order using a sorting rule, wherein each defect candidate is associated with a distinct ranking in the total order representative of the likelihood of the defect candidate being a defect of interest (DOI), wherein the decision model is previously trained to learn the sorting rule pertaining to the plurality of defect classes associated with the group of defect candidates and a series of attributes in the inspection data.

In accordance with other aspects of the presently disclosed subject matter, there is provided a computerized method of training machine-learning (ML) based examination system, the method comprising: obtaining a training dataset informative of a group of defect candidates and attributes thereof resulting from examining one or more semiconductor specimens by at least an inspection tool and a review tool, the attributes comprising a first attribute indicative of defect classes of the group of defect candidates generated by a classifier, the classifier previously trained based on training data derived from a subset of defect candidates in the training dataset that is reviewed by the review tool and has a second attribute indicative of ground truth defect classes thereof; and training a decision model using the training dataset, to learn a sorting rule pertaining to a series of attributes including the first attribute, the sorting rule usable for ranking the group of defect candidates into a total order in accordance with the ground truth defect classes indicated by the second attribute, where each defect candidate is associated with a distinct ranking in the total order representative of the likelihood of the defect candidate being a defect of interest (DOI).

These aspects of the disclosed subject matter can comprise one or more of features (i) to (x) listed above with respect to the system, mutatis mutandis, in any desired combination or permutation which is technically possible.

In addition to the above features, the methods according to these aspects of the presently disclosed subject matter can comprise one or more of features (xi) to (xvi) listed below, in any desired combination or permutation which is technically possible:
(xi). The training dataset is represented as a tabular dataset.
(xii). The obtaining a training dataset comprises: obtaining an original dataset informative of the group of defect candidates and attributes thereof resulting from examining the one or more semiconductor specimens by at least an inspection tool and a review tool, the original dataset including the subset of defect candidates that is reviewed by the review tool and has the second attribute indicative of ground truth defect classes thereof; clustering the subset of defect candidates into a plurality of clusters based on values of the attributes thereof; and classifying, using the classifier, the group of defect candidates into a plurality of defect classes, wherein the classifier is pre-trained using the training data including at least the plurality of clusters of defect candidates.
(xiii). The normalizing of the original dataset comprises: transforming values of each given attribute of at least some of the attributes in the original dataset into a specific distribution, and evaluating transformation error of the transformation to determine whether to filter the given attribute from the original dataset, giving rise to a normalized dataset with filtered attributes each having normalized values, the normalized dataset including a normalized subset corresponding to the subset of defect candidates, and wherein the clustering is performed on the normalized subset based on the normalized values of the filtered attributes thereof.
(xiv). The method further comprises partitioning the original dataset into a plurality of sub-spaces based on one or more attributes, and the normalizing, clustering, and classifying are performed for each sub-space.
(xv). The training data is generated by verifying whether the plurality of defect classes each comprises a sufficient number of defect candidates, and whether the defect classes are balanced with respect to each other, and in cases where a given defect class does not have sufficient candidates, generating synthetic defect candidates for the given defect class, and associating each synthetic defect candidate with ground truth of the given class.
(xvi). The one or more semiconductor specimens comprise one or more layers of one or more semiconductor wafers.

In accordance with other aspects of the presently disclosed subject matter, there is provided a non-transitory computer readable medium comprising instructions that, when executed by a computer, cause the computer to perform a computerized method of defect examination on a semiconductor specimen, the method comprising: obtaining an inspection dataset informative of a group of defect candidates and attributes thereof resulting from examining the semiconductor specimen by an inspection tool; classifying, by a classifier, the group of defect candidates into a plurality of defect classes such that each defect candidate is associated with a respective defect class; and ranking, by a decision model, the group of defect candidates into a total order using a sorting rule, wherein each defect candidate is associated with a distinct ranking in the total order representative of the likelihood of the defect candidate being a defect of interest (DOI), wherein the decision model is previously trained to learn the sorting rule pertaining to the plurality of defect classes associated with the group of defect candidates and a series of attributes in the inspection data.

In accordance with other aspects of the presently disclosed subject matter, there is provided a non-transitory computer readable medium comprising instructions that, when executed by a computer, cause the computer to perform a computerized method of training machine-learning (ML) based examination system, the method comprising: obtaining a training dataset informative of a group of defect candidates and attributes thereof resulting from examining one or more semiconductor specimens by at least an inspection tool and a review tool, the attributes comprising a first attribute indicative of defect classes of the group of defect candidates generated by a classifier, the classifier previously trained based on training data derived from a subset of defect candidates in the training dataset that is reviewed by the review tool and has a second attribute indicative of ground truth defect classes thereof; and training a decision model using the training dataset, to learn a sorting rule pertaining to a series of attributes including the first attribute, the sorting rule usable for ranking the group of defect candidates into a total order in accordance with the ground truth defect classes indicated by the second attribute, where each defect candidate is associated with a distinct ranking in the total order representative of the likelihood of the defect candidate being a defect of interest (DOI).

These aspects of the disclosed subject matter can comprise one or more of features (i) to (xvi) listed above with respect to the system and/or the method, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of training a machine-learning based examination system usable for defect examination on a semiconductor specimen in accordance with certain embodiments of the presently disclosed subject matter.

FIG. 3 illustrates a generalized flowchart of data pre-processing for generating the training dataset used to train the machine-learning based examination system in accordance with certain embodiments of the presently disclosed subject matter.

FIG. 4 illustrates a generalized flowchart of a data normalization process in accordance with certain embodiments of the presently disclosed subject matter.

FIG. 5 shows a generalized flowchart of training a classifier usable for classifying a group of defect candidates resulting from defect inspection in accordance with certain embodiments of the presently disclosed subject matter.

FIG. 6 illustrates a generalized flowchart of runtime defect examination on a semiconductor specimen using a trained ML based examination system in accordance with certain embodiments of the presently disclosed subject matter.

FIG. 7 illustrates a schematic illustration of an example of a tabular dataset and an example of a sorted table corresponding to the tabular dataset in accordance with certain embodiments of the presently disclosed subject matter.

FIG. 8 schematically illustrates sub-spacing in the attribute space in accordance with certain embodiments of the presently disclosed subject matter.

FIG. 9 is a schematic illustration of an exemplary data normalization in accordance with certain embodiments of the presently disclosed subject matter.

FIG. 10 illustrates an example of defect clusters generated based on inspection attributes and defect classes provided by a review tool in accordance with certain embodiments of the presently disclosed subject matter.

### DETAILED DESCRIPTION OF EMBODIMENTS

The process of semiconductor manufacturing often requires multiple sequential processing steps and/or layers, each one of which could possibly cause errors that may lead to yield loss. Examples of various processing steps can include lithography, etching, depositing, planarization, growth (such as, e.g., epitaxial growth), and implantation, etc. Various examination operations, such as defect-related examination (e.g., defect detection, defect review and defect classification, etc.), and/or metrology-related examination, can be performed at different processing steps/layers during the manufacturing process to monitor and control the process. The examination operations can be performed a multiplicity of times, for example after certain processing steps, and/or after the manufacturing of certain layers, or the like.

Run-time defect examination generally employs a two-phase procedure, e.g., inspection of a specimen followed by review of sampled locations of potential defects. Examination generally involves generating certain output (e.g., images, signals, etc.) for a specimen by directing light or electrons to the wafer, and detecting the response from the wafer. During the first phase, the surface of a specimen is inspected at high-speed and relatively low-resolution. Defect detection is typically performed by applying a defect detection algorithm to the inspection output. A defect map is produced to show suspected locations of defect candidates on the specimen having a high probability of being a defect of interest (DOI).

In a typical wafer, the order of magnitude of the number of defect candidates, as revealed by inspection, may be between tens of thousands or millions. It is impractical to review each and every defect candidate in order to determine whether it is a DOI, or a nuisance. Therefore, a small fraction of the defect candidates, for example between a few dozen and a few thousand defects, are selected to be more thoroughly reviewed and analyzed with relatively high resolution in the second phase, for determining different parameters of the defects, such as classes, thickness, roughness, size, and so on. Defect examination conclusions may be drawn based on the review results.

As semiconductor fabrication processes continue to advance, semiconductor devices are developed with increasingly complex structures with decreasing feature dimensions. As the design rules shrink, there are more presence of smaller defects. The population of both DOIs (which are yield related), and nuisances detected by inspection, grows dramatically, causing a relatively high nuisance rate, thus drives more sensitive inspections. Inspection becomes even more important to the successful manufacture of acceptable semiconductor devices, as smaller defects have an impact on the electrical parameters of the device and can cause the devices to fail. Most often, the goal of inspection is to provide high sensitivity for DOI detection, while suppressing detection of nuisances and noises among the defect candidates revealed on the wafer. To this end, the ability to select the most probable defect candidates to be reviewed (subject to the capacity of the review budget of a review tool) is much desired.

Accordingly, certain embodiments of the presently disclosed subject matter propose to use a machine-learning based defect examination system, which addresses one or more of the issues described above. The present disclosure proposes to provide a runtime defect examination system capable of providing a total order of ranking for all defect candidates revealed by inspection, where each defect candidate is associated with its respective ranking representative of the likelihood of the defect candidate being a DOI. Such ranking can be used for selecting a list of the most probable defect candidates to be reviewed by a review tool, thus improving defect detection sensitivity and capture rate, as will be detailed below.

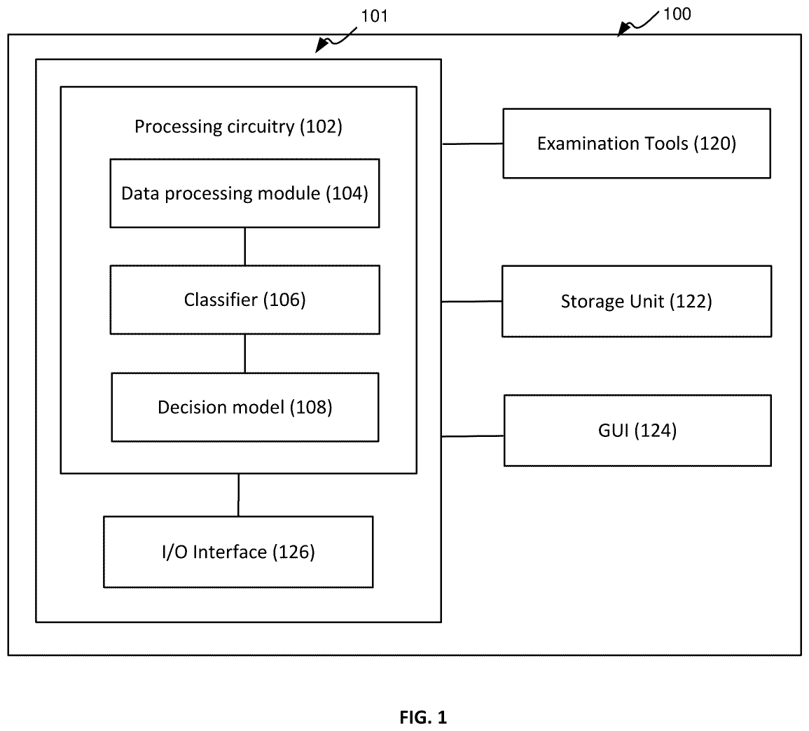

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication process. As described above, the examination referred to herein can be construed to cover any kind of operations related to defect inspection/detection, defect classification, segmentation, and/or metrology operations, etc., with respect to the specimen. System 100 comprises one or more examination tools 120 configured to scan a specimen and capture images thereof to be further processed for various examination applications.

The term “examination tool(s)” used herein should be expansively construed to cover any tools that can be used in examination-related processes including, by way of non-limiting example, scanning (in a single or in multiple scans), imaging, sampling, reviewing, measuring, classifying, and/or other processes provided with regard to the specimen or parts thereof. Without limiting the scope of the disclosure in any way, it should also be noted that the examination tools 120 can be implemented as inspection machines of various types, such as optical inspection machines, electron beam inspection machines (e.g., Scanning Electron Microscope (SEM), Atomic Force Microscopy (AFM), or Transmission Electron Microscope (TEM), etc.), and so on.

The one or more examination tools 120 can include one or more inspection tools and/or one or more review tools. In some cases, at least one of the examination tools 120 can be an inspection tool configured to scan a specimen (e.g., an entire wafer, an entire die, or portions thereof) to capture inspection images (typically, at a relatively high-speed and/or low-resolution) for detection of potential defects (i.e., defect candidates). During inspection, the wafer can move at a step size relative to the detector of the inspection tool (or the wafer and the tool can move in opposite directions relative to each other) during the exposure, and the wafer can be scanned step-by-step along swaths of the wafer by the inspection tool, where the inspection tool images a part/portion (within a swath) of the specimen at a time. By way of example, the inspection tool can be an optical inspection tool. At each step, light can be detected from a rectangular portion of the wafer and such detected light is converted into multiple intensity values at multiple points in the portion, thereby forming an image corresponding to the part/portion of the wafer. For instance, in optical inspection, an array of parallel laser beams can scan the surface of a wafer along the swaths. The swaths are laid down in parallel rows/columns contiguous to one another to build up, swath-at-a-time, an image of the surface of the wafer. For instance, the tool can scan a wafer along a swath from up to down, then switch to the next swath and scan it from down to up, and so on and so forth, until the entire wafer is scanned and inspection images of the wafer are collected.

In some cases, at least one of the examination tools 120 can be a review tool, which is configured to capture review images of at least some of the defect candidates detected by inspection tools for ascertaining whether a defect candidate is indeed a defect of interest (DOI). Such a review tool is usually configured to inspect fragments of a specimen, one at a time (typically, at a relatively low-speed and/or high-resolution). By way of example, the review tool can be an electron beam tool, such as, e.g., scanning electron microscopy (SEM), etc. SEM is a type of electron microscope that produces images of a specimen by scanning the specimen with a focused beam of electrons. The electrons interact with atoms in the specimen, producing various signals that contain information on the surface topography and/or composition of the specimen. SEM is capable of accurately inspecting and measuring features during the manufacture of semiconductor wafers.

The inspection tool and review tool can be different tools located at the same or at different locations, or a single tool operated in two different modes. In some cases, the same examination tool can provide low-resolution image data and high-resolution image data. The resulting image data (low-resolution image data and/or high-resolution image data) can be transmitted-directly or via one or more intermediate systems—to system 101. The present disclosure is not limited to any specific type of examination tools and/or the resolution of image data resulting from the examination tools. In some cases, at least one of the examination tools 120 has metrology capabilities and can be configured to capture images and perform metrology operations on the captured images. Such an examination tool is also referred to as a metrology tool.

According to certain embodiments of the presently disclosed subject matter, the examination system 100 comprises a computer-based system 101 operatively connected to the examination tools 120 and capable of automatic defect examination on a semiconductor specimen. System 101 is also referred to as a defect examination system (also referred to as defect ranking system), and/or a training system for training the defect examination system which is machine learning based.

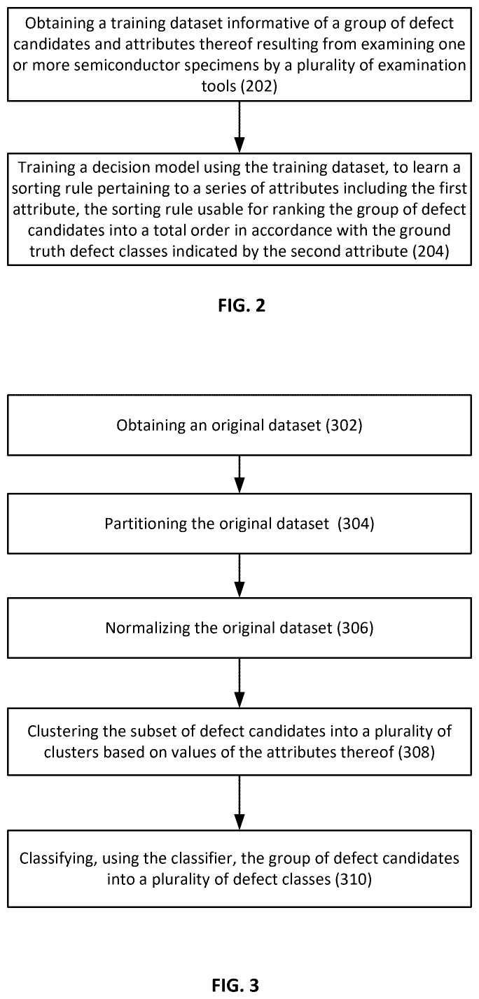

System 101 includes a processing circuitry 102 operatively connected to a hardware-based I/O interface 126 and configured to provide processing necessary for operating the system, as further detailed with reference to FIGS. 2-6. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

The one or more processors referred to herein can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

According to certain embodiments of the presently disclosed subject matter, system 101 can be a runtime defect examination system configured to perform defect examination operations using one or more trained machine learning (ML) models based on runtime images obtained during specimen fabrication. In such cases, the functional modules comprised in the processing circuitry 102 of system 101 can include a classifier 106 and a decision model 108 that were previously trained ML models operatively connected therebetween, and, optionally, a data processing module 104.

Specifically, the processing circuitry 102 can be configured to obtain, via an I/O interface 126, an inspection dataset informative of a group of defect candidates and attributes thereof resulting from examining a semiconductor specimen by an inspection tool. The classifier 106 is a pre-trained classifier configured to classify the group of defect candidates into a plurality of classes. The decision model 108 is also pre-trained, and is configured to rank the group of defect candidates into a total order using a sorting rule, where each defect candidate is associated with a distinct ranking in the total order representative of the likelihood of the defect candidate being a defect of interest (DOI). In some cases, optionally, the data processing module 104 can be configured to pre-process the inspect dataset, such as sub-spacing, and/or normalization, etc., and feed the pre-processed data to the classifier 106.

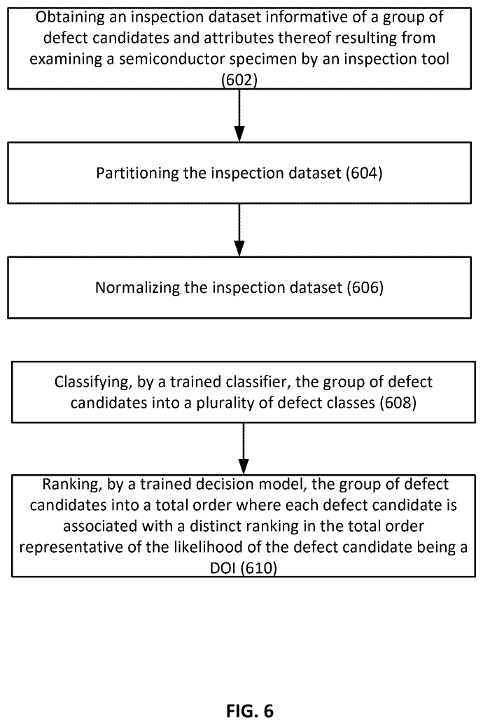

In such cases, the above modules, such as the classifier 106 and decision model 108 can be regarded as part of a defect examination recipe usable for performing runtime defect examination operations on runtime inspection data. System 101 can be regarded as a runtime defect examination system (or defect ranking system) capable of performing runtime defect-related operations using the defect examination recipe. Details of the runtime examination process are described below with reference to FIG. 6.

In some embodiments, system 101 can be configured as a training system capable of training the ML-based examination system during a training/setup phase. In such cases, the functional modules comprised in the processing circuitry 102 of system 101 can include a training module (not illustrated in FIG. 1), a classifier 106 to be trained, and a decision model 108 to be trained. The training module can be configured to obtain a training dataset informative of a group of defect candidates and attributes thereof resulting from examining one or more semiconductor specimens by a plurality of examination tools including at least an inspection tool and at least a review tool.

The attributes comprise a first attribute indicative of defect classes of the defect candidates generated by a classifier, which is previously trained based on training data derived from a subset of defect candidates in the training dataset. The subset of defect candidates is reviewed by a review tool and has a second attribute indicative of ground truth defect classes thereof.

The training module can be further configured to train a decision model using the training dataset, to learn a sorting rule pertaining to a series of attributes including the first attribute. The sorting rule is usable for ranking the defect candidates into a total order in accordance with the ground truth defect classes indicated by the second attribute, where each defect candidate is associated with a distinct ranking in the total order representative of the likelihood of the defect candidate being a defect of interest (DOI).

Optionally, the processing circuitry 102 in the training system 101 can include one or more additional modules such as, e.g., a data processing module 104, a clustering module (not illustrated in the figure), and a training data generator (not illustrated in the figure), etc. These modules, together with the classifier 106 and the decision model 108, can be operatively connected in a sequence, where the decision model is the last functional module for providing the final output. In some cases, at least some or all of these modules can be ML based. In such cases, the training module can be configured to train each of the ML based modules in turn. A given module, once being trained, can be deployed in inference, so as to provide input data for training the next module in line. Optionally, each given ML based module can have their respective training module specifically configured to train the given module.

In some embodiments, the training system 101 can be regarded as a training system for preparing a training dataset and using the training set to train the decision model 108, while in some other cases, the training system 101 can be regarded as a training system for training at least some or all the ML-based modules, which form a ML based examination system. Details of the training process are described below with reference to FIGS. 2-5.

Operations of systems 100 and 101, the processing circuitry 102, and the functional modules therein will be further detailed with reference to FIGS. 2-6.

According to certain embodiments, the various ML based modules referred to herein can be implemented as various types of machine learning models, such as, e.g., decision tree, Support Vector Machine (SVM), Artificial Neural Network (ANN), regression model, Bayesian network, etc., or ensembles/combinations thereof. The learning algorithm used by the ML model can be any of the following: supervised learning, unsupervised learning, self-supervised, or semi-supervised learning, etc. The presently disclosed subject matter is not limited to the specific type of ML model or the specific type of learning algorithm used by the ML model.

In some embodiments, at least some of the ML based modules can be implemented as a deep neural network (DNN). DNN can comprise multiple layers organized in accordance with respective DNN architecture. By way of non-limiting example, the layers of DNN can be organized in accordance with Convolutional Neural Network (CNN) architecture, Recurrent Neural Network architecture, Recursive Neural Networks architecture, Generative Adversarial Network (GAN) architecture, or otherwise. Optionally, at least some of the layers can be organized into a plurality of DNN sub-networks. Each layer of DNN can include multiple basic computational elements (CE) typically referred to in the art as dimensions, neurons, or nodes.

The weighting and/or threshold values associated with the CEs of a deep neural network and the connections thereof can be initially selected prior to training, and can be further iteratively adjusted or modified during training to achieve an optimal set of weighting and/or threshold values in a trained DNN. After each iteration, a difference can be determined between the actual output produced by the DNN module and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a deep neural network is referred to as a training set.

It is noted that the teachings of the presently disclosed subject matter are not bound by specific architecture of the ML model or DNN as described above.

It is to be noted that while certain embodiments of the present disclosure refer to the processing circuitry 102 being configured to perform the above recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as, e.g., processing the inspection data, classifying the group of defect candidates, and ranking the defect candidates, etc., can thus be performed by respective processors (or processor combinations) in the processing circuitry 102, while, optionally, these operations may be performed by the same processor. The present disclosure should not be limited to being construed as one single processor always performing all the operations.

In some cases, additionally to system 101, the examination system 100 can comprise one or more examination modules, such as, e.g., defect detection module, Automatic Defect Review Module (ADR), Automatic Defect Classification Module (ADC), metrology operation module, and/or other examination modules which are usable for examination of a semiconductor specimen. The one or more examination modules can be implemented as stand-alone computers, or their functionalities (or at least part thereof) can be integrated with the examination tool 120. In some cases, the output of system 101, e.g., the trained ML models, the ranked defect candidates, etc., can be provided to the one or more examination modules (such as the ADR, ADC, etc.) for further processing.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store images, datasets and/or derivatives thereof resulting from examination of the specimens by the examination tool 120. Accordingly, these input data can be retrieved from the storage unit 122 and provided to the processing circuitry 102 for further processing. The output of the system 101, such as, e.g., the trained ML models, the ranked defect candidates, etc., can be sent to storage unit 122 to be stored.

In some embodiments, system 100 can optionally comprise a computer-based Graphical User Interface (GUI) 124 which is configured to enable user-specified inputs related to system 101. For instance, the user can be presented with a visual representation of the specimen (for example, by a display forming part of GUI 124), including, e.g., images, defect candidate distribution, clusters, and classes, etc. on the specimen. The user may be provided, through the GUI, with options of defining certain operation parameters. The user may also view the operation results or intermediate processing results, such as, e.g., the ranked defect candidates, etc., on the GUI.

In some cases, system 101 can be further configured to send, via I/O interface 126, the operation results to the examination tool 120 for further processing. In some cases, system 101 can be further configured to send the results to the storage unit 122, and/or external systems (e.g., Yield Management System (YMS) of a fabrication plant (fab)). A yield management system (YMS) in the context of semiconductor manufacturing is a data management, analysis, and tool system that collects data from the fab, especially during manufacturing ramp ups, and helps engineers find ways to improve yield. YMS helps semiconductor manufacturers and fabs manage high volumes of production analysis with fewer engineers. These systems analyze the yield data and generate reports. YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules and functions than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned components and functional modules shown in FIG. 1 can be distributed over several local and/or remote devices. By way of example, the examination tools 120 and the system 101 can be located at the same entity (in some cases hosted by the same device) or distributed over different entities. By way of another example, as described above, in some cases, system 101 can be configured as a training system for training the ML model, while in some other cases, system 101 can be configured as a runtime defect examination system using the trained ML based system. The training system and the runtime examination system can be located at the same entity (in some cases hosted by the same device), or distributed over different entities, depending on specific system configurations and implementation needs.

In some examples, certain components utilize a cloud implementation, e.g., implemented in a private or public cloud. Communication between the various components of the examination system, in cases where they are not located entirely in one location or in one physical entity, can be realized by any signaling system or communication components, modules, protocols, software languages and drive signals, and can be wired and/or wireless, as appropriate.

It should be further noted that in some embodiments at least some of examination tools 120, storage unit 122 and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tools 120, thereby facilitating and enhancing the functionalities of the examination tools 120 in examination-related processes.

While not necessarily so, the process of operation of systems 101 and 100 can correspond to some or all of the stages of the methods described with respect to FIGS. 2-6. Likewise, the methods described with respect to FIGS. 2-6 and their possible implementations can be implemented by systems 101 and 100. It is therefore noted that embodiments discussed in relation to the methods described with respect to FIGS. 2-6 can also be implemented, mutatis mutandis as various embodiments of the systems 101 and 100, and vice versa.

Referring to FIG. 2, there is illustrated a generalized flowchart of training a machine-learning based examination system usable for defect examination on a semiconductor specimen in accordance with certain embodiments of the presently disclosed subject matter.

A training dataset can be obtained (202) (e.g., by a training module in processing circuitry 102), informative of a group of defect candidates and attributes thereof resulting from examining one or more semiconductor specimens by a plurality of examination tools (e.g., by the examination tools 120). The plurality of examination tools can include at least an inspection tool and a review tool. The training dataset is used for the purpose of training a decision model, as described below in further detail. The training dataset can be represented in various data structures and formats. By way of example, in some cases, the training dataset can be a tabular dataset where the training data is stored in a table or table-like format.

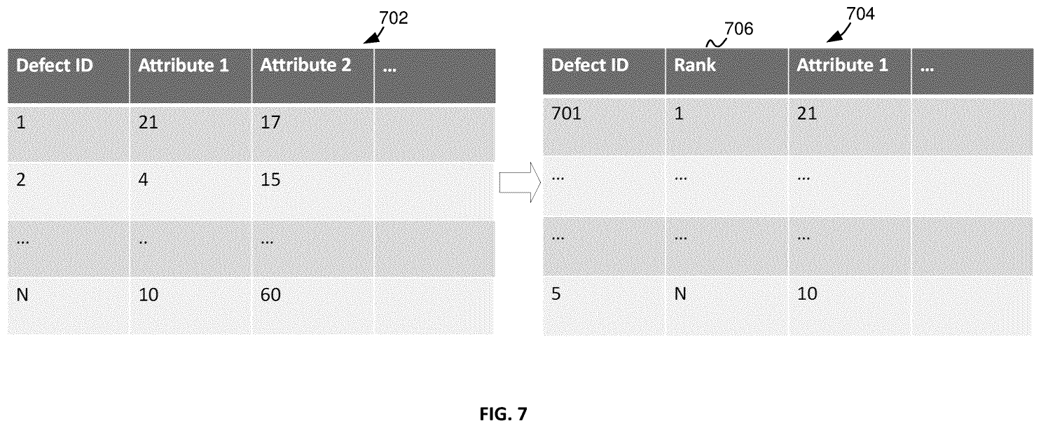

FIG. 7 illustrates an example of a tabular dataset in accordance with certain embodiments of the presently disclosed subject matter. The training dataset comprising N defect candidates is stored in a table 702, where each row represents a specific defect candidate (identified by its defect ID) in the group of defect candidates, and each column represents an attribute of the defect candidate. The group of defect candidates results from examination of one or more specimens by multiple examination tools including, such as, e.g., one or more inspection tools, and one or more review tools. In some embodiments, the group of defect candidates refers to the entire population of defect candidates as revealed during inspection, which is in the magnitude of tens of thousands or millions. The attributes of these defect candidates include inspection attributes obtained during defect inspection by the inspection tools.

By way of example, during inspection, an inspection tool can capture inspection images of a specimen (e.g., a wafer, a die, or part thereof). The captured images of the specimen can be processed using various defect detection algorithms to generate a defect map indicative of defect candidate distribution on the specimen (e.g., suspected locations on the specimen having high probability of being defect of interests (DOIs)). The generated defect map can be informative of inspection attributes such as, e.g., locations, strength, size, volume, grade, polarity, etc. of the defect candidates. Optionally, in some cases, additional attributes can be also collected, including image characteristics corresponding to the defect candidates such as, e.g., gray level intensities, contrast, etc., as well as acquisition information, such as acquisition time, acquisition tool ID, region ID, wafer ID, etc. The defect maps and all the attributes collected from different specimens and/or different tools can be combined to generate the tabular dataset.

As described above, among all the defect candidates revealed by the inspection tool, a subset of the defect candidates can be selected and reviewed by a review tool. The review tool can capture review images with higher resolution at locations of a selected subset of defect candidates, and review the review images for ascertaining whether a defect candidate is a DOI or nuisance. The output of the review tool can include labels respectively associated with the selected defect candidates and indicative of defect classes/types of the defect candidates. The defect classes of the subset of candidates provided by the review tool can be regarded as ground truth defect classes of these candidates. In such cases, the tabular dataset can comprise a subset of the defect candidates reviewed by the review tool, for which an attribute is included in the tabular dataset indicative of the ground truth defect classes as provided by the review tool (the remaining candidates which were not reviewed by the review tool can be regarded as having an “unknown” value for this attribute).

In addition, training data can be derived based on the subset of defect candidates reviewed by a review tool and associated with the ground truth defect classes thereof. The training data can be used to train a classifier for defect classification. The classifier, upon being trained, can be used to classify the entire group of defect candidates in the tabular dataset. The defect classes of the defect candidates provided by the classifier can be included as an attribute in the tabular dataset.

Specifically, the training dataset (e.g., the tabular dataset) obtained in block 202 can comprise, among other attributes, a first attribute indicative of defect classes of the defect candidates generated by a classifier, where the classifier is previously trained based on training data derived from a subset of defect candidates in the training dataset that is reviewed by a review tool and has a second attribute indicative of ground truth defect classes thereof. The training process of the classifier is detailed below with reference to FIG. 5.

The training dataset can be used to train (204) (e.g., by the training module in processing circuitry 102) a decision model, so that the decision model learns a sorting rule pertaining to a series of attributes including the first attribute. The sorting rule is usable for ranking the group of defect candidates into a total order in accordance with the ground truth defect classes indicated by the second attribute. Each defect candidate is associated with a distinct ranking in the total order representative of the likelihood of the defect candidate being a defect of interest (DOI).

A total order, or a full order, as used herein, refers to an order within a group of candidates where each candidate has a unique/distinct ranking in the order that is non-overlapping with others. For instance, if a group has n defect candidates, after being processed by the trained decision model, the n defect candidates will be respectively ranked from 1 to n, where each candidate has its unique ranking in the order. In other words, there will not be a situation where two or more candidates share the same ranking in this order.

FIG. 7 illustrates an example of a sorted table 704 corresponding to the table 702 which represents the tabular dataset to be processed by the decision model. As shown, table 706 has added a new column “rank” as compared to table 702, where each of the N defect candidates is associated with its unique ranking in the total order of 1-n. The N defect candidates are sorted in accordance with a descending order of the column “Rank”, such that the defect candidates having the highest likelihood of being DOIs are listed at the top. For instance, the defect candidate with ID 701 is ranked first, indicating the candidate, among all the candidates, is most likely to be a DOI.

It is to be noted that although the dataset is illustrated in FIG. 7 in the format of a table, this is for exemplary purposes only, and should not be regarded as limiting the present disclosure. Any other suitable representation of such a dataset, including defect candidates and the attributes thereof, can be used in lieu of the tabular format. For instance, any of the following table-like structures can be used instead of the tabular format when appropriate: lists, graphs, matrices, or general binary relations, etc.

Turning now to FIG. 3, there is illustrated a generalized flowchart of data pre-processing for generating the training dataset used to train the machine-learning based examination system (e.g., the training dataset referred to in block 202) in accordance with certain embodiments of the presently disclosed subject matter.

An original dataset can be obtained (302), informative of a group of defect candidates and attributes thereof resulting from examining one or more semiconductor specimens by at least an inspection tool and a review tool. The original dataset includes a subset of defect candidates that is reviewed by a review tool and has a second attribute indicative of ground truth defect classes thereof. The difference between the original dataset and the eventual training dataset described above with respect to block 202 resides in that the original dataset refers to the raw data of defect candidates and their attributes directly collected from the tools. It does not include the first attribute indicative of defect classes of the group of defect candidates which is generated by a subsequent defect classification process applied to the group of defect candidates by a classifier (as will be described in further detail with reference to FIG. 5).

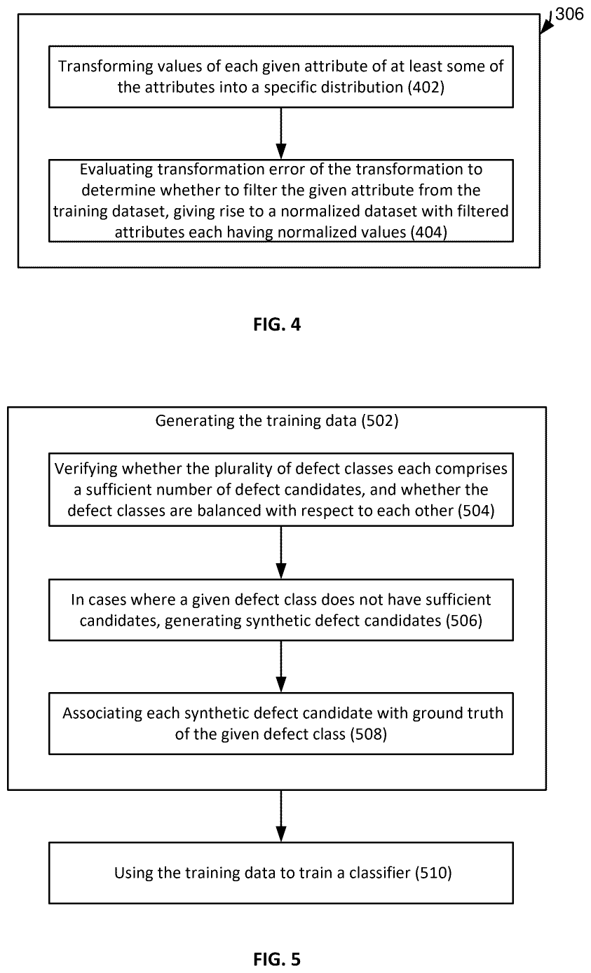

The subset of defect candidates can be clustered (308) into a plurality of clusters based on values of the attributes thereof. In some cases, optionally, the original dataset can be normalized (306) (e.g., by the data processing module 104 in the processing circuitry 102) prior to being clustered. FIG. 4 illustrates a generalized flowchart of a data normalization process in accordance with certain embodiments of the presently disclosed subject matter.

Values of each given attribute of at least some of the attributes in the original dataset can be automatically fitted/transformed (402) into a specific distribution. The transformed dataset can be from one or more types of data distribution such as, e.g., normal distribution (also known as Gaussian distribution), beta distribution, gamma distribution, Poisson distribution, Binomial distribution, and exponential distribution, etc. The data transformation can be performed by a transformation model which learns the data characteristics of the attribute values so as to fit them to different data distributions. By way of example, a given attribute having values bounded between any two distinct numbers, such as, e.g., −100 and 100, can be transformed to a fitted beta distribution which represents a continuous probability distribution between 0 and 1.

The transformation model used to perform data transformation can be implemented as a mathematical model or a machine learning model. By way of example, machine learning models such as, e.g., neural networks, support vector machines (SVMs), decision trees, or Gaussian mixture models (GMMs), etc., can be used as the transformation model.

Transformation error of the transformation can be evaluated (404) to determine whether to filter the given attribute from the original dataset. Depending on the specific attribute and the target distribution, various tests can be used to compare the distribution of the transformed attribute values with a target distribution, and calculate the transformation error which measures how well the transformed attribute values fit the target distribution. By way of example, mean squared error (MSE) can be calculated between the transformed attribute values and the target distribution, indicative of the average squared difference between the two distributions. A small MSE indicates that the transformed values are a good fit to the target distribution.

The transformation error can reflect the transformation feasibility of the values of a given attribute with respect to any specific data distribution, which further indicates the quality of the given attribute. By way of example, in cases where a given attribute, after data transformation, cannot fit to any data distribution (e.g., having a large transformation error), such an attribute can be determined to be filtered from the dataset.

Upon evaluation and possible filtration, a normalized dataset is created, comprising filtered attributes, each having normalized values (e.g., the transformed values after data transformation). As data normalization is performed on the entire dataset, including the subset of defect candidates that was reviewed by a review tool, the normalized dataset naturally includes a normalized subset corresponding to the subset of defect candidates. In such cases where data normalization is performed, the clustering in block 308 should be performed on the normalized subset based on the normalized values of the filtered attributes thereof.

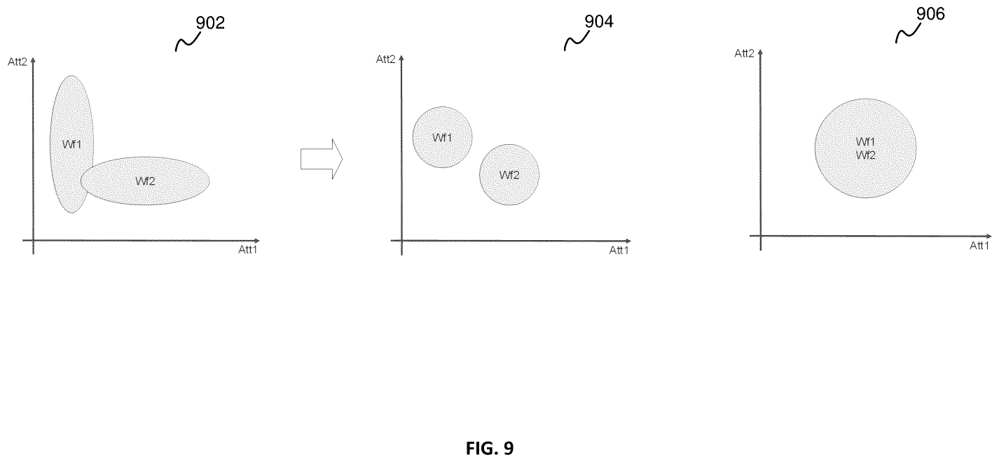

FIG. 9 shows a schematic illustration of an exemplary data normalization in accordance with certain embodiments of the presently disclosed subject matter.

Assume the dataset includes defect data collected from two wafers wf1 and wf2, which are characterized by at least two attributes 1 and 2. Due to different variations such as, e.g., process variations and wafer-to-wafer variations, the defect data from the two wafers may not be on the same scales/ranges, as illustrated in graph 902. In such cases, data normalization is necessary, as data normalization can transform defect data of the two wafers into a common scale, without distorting differences in the ranges of values. By way of example, the values of the two attributes 1 and 2 can be respectively normalized, e.g., by data transformation to a respective distribution, thus giving rise to normalized defect data with normalized values of the two attributes which share a common range, as shown in graph 906. In some cases, an intermediate step of the transformation may be needed, as exemplified in graph 904, where the defect data of both wafers are scaled, which are then translated or shifted, according to the fitted model, into the final transformed values in graph 906.

Data normalization, in such cases, can make the data from different sources more stable/robust and comparable, which, when being used for later ML based processing, can improve the performance of the ML algorithms, such as in their stability and accuracy. In addition, it is proven that data transformation and attribute filtration can increase DOI similarity, thus facilitating differentiating the DOIs from the remaining nuisance population.

The original dataset can be represented in a multi-dimensional attribute space, where each dimension represents an attribute. A defect candidate can be represented by a data point in the multi-dimensional space, characterized by the values of the multiple attributes. In some embodiments, optionally, the original dataset can be partitioned (304) into a plurality of sub-spaces based on one or more attributes (and/or the values thereof) in the attribute space (also referred to as sub-spacing). By way of example, the sub-spacing can be based on attributes indicative of different wafers and/or different examination tools, so as to split data resulting from different data sources. By way of another example, the sub-spacing can be based on some values of certain subset of attributes, such as, e.g., void values of certain attributes.

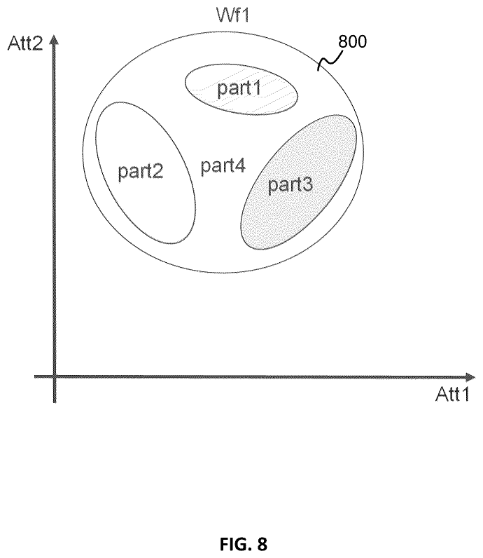

FIG. 8 shows a schematic illustration of sub-spacing in the attribute space in accordance with certain embodiments of the presently disclosed subject matter. A dataset collected from wafer 1 is represented in a 2D attribute space. The attribute space 800 of the dataset can be partitioned into four sub-spaces, denoted as parts 1-4 in the figure, based on the values of the two attributes. In cases of sub-spacing, the subsequent processing, such as the normalizing (306), clustering (308), and classifying (310), can be performed for each sub-space.

Continuing with the description of FIG. 3, the subset of defect candidates can be clustered (308) (e.g., by a clustering module in the processing circuitry 102) into a plurality of clusters based on values of the attributes thereof. As aforementioned, in cases of data normalization prior to the clustering, the clustering is performed on the normalized subset based on the normalized values of the filtered attributes thereof.

The clustering module can be configured to find groups of defect candidates that are similar to each other in terms of their attributes. By way of example, the clustering module can cluster the defect candidates represented in the attribute space into a plurality of clusters based on their attributes, such that the distance between any given candidate and another candidate in the same cluster is smaller than the distance between the given candidate and a third candidate assigned to another cluster. The clustering module can determine separation planes which are used to form the boundaries between the clusters within the attribute space.

Although the subset of defect candidates is already reviewed by a review tool and is associated with ground truth defect classes, the classification was performed by the review tool based on high resolution images (e.g., SEM images captured by a SEM tool). In other words, the defect candidates in the subset were classified under a SEM setting in a SEM attribute space, whereas the defect candidates of the original dataset (or the normalized dataset) are collected from one or more inspection tools, thus are mainly associated with inspection attributes, as described above. The clusters, grouped based on the inspection attributes, are not necessarily consistent with the defect classes generated based on review attributes.

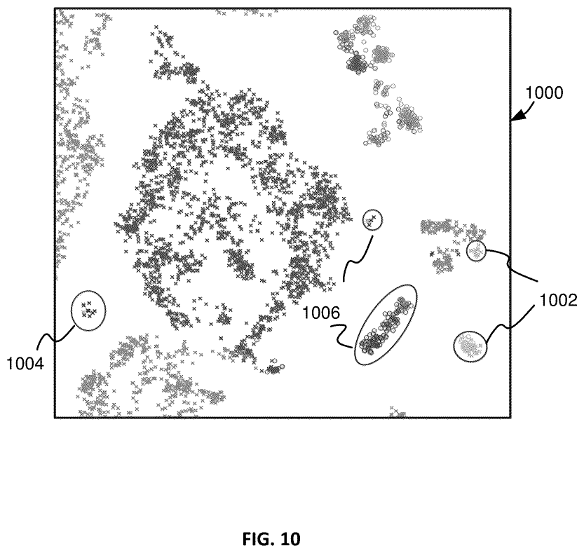

FIG. 10 illustrates an example of defect clusters generated based on inspection attributes, and defect classes provided by a review tool in accordance with certain embodiments of the presently disclosed subject matter.

Graph 1000 illustrates a subset of defect candidates resulting from inspection tools which were previously reviewed by a review tool and given ground truth defect classes. The subset of defect candidates is now clustered in attribute space based on their inspection attributes. As shown, defect group 1002 was previously classified by a review tool as belonging to the same defect class (indicated by the same gray levels in the figure). When being clustered based on inspection attributes, the defect group 1002 is presently clustered as two clusters, as illustrated. In contrast, defect group 1004 is presently clustered as a single cluster, which, when previously reviewed by a review tool, was classified as belonging to two different defect classes. In addition, one defect class classified by the review tool is now distributed to a few clusters, including clusters 1006 as well as cluster 1004.

Therefore, as exemplified in FIG. 10, the defect classes provided by the review tool based on review attributes, are not necessarily accurate in the inspection attribute space. Using the subset of defect candidates associated with such classes directly as training data to train a classifier for defect classification of defect candidates resulting from inspection tools, may possibly mislead the classifier to create separation planes that, when being used, may cause degradation of classification accuracy.

Therefore, it is beneficial to cluster (in other words, re-classify) the subset of defect candidates (or a normalized subset) into a plurality of clusters based on values of the attributes thereof, as described above with reference to block 308. The defect classes and/or the defect clusters as referred to herein can be broadly construed to cover any defect classes, such as, e.g., DOIs and nuisances, optionally with additional classes such as unknown (i.e., unlabeled candidates which are unknown to the classifier) and do not care (DNC) (i.e., classes that are indifferent to the user). In some cases, the defect classes can also cover specific defect types thereof (e.g., as sub-classes or class codes of DOI).

Continuing with the description of FIG. 3, a classifier can be used to classify (310) the group of defect candidates (in the original dataset or normalized dataset) into a plurality of defect classes. The classifier is pre-trained using training data, including at least the plurality of clusters of defect candidates as provided by the clustering process described above with reference to block 308.

The term “classifier”, or “classifier module” referred to herein should be broadly construed to cover any learning model capable of identifying to which of a set of categories/classes a new instance belongs, on the basis of a training set of data. In some cases, the classifier can classify the defect candidates into two classes: DOI or nuisance. In such cases, the classifier is a binary classifier and can also be referred to as a filter or a nuisance filter, which is configured to filter out nuisance type of defect candidates from the defect map. In some other cases, the classifier can identify specific defect types of the defect candidates, such as, e.g., a bridge, particle, etc. By way of example, the classifier can classify the defect candidates into DOIs and nuisances, and for the candidates classified as DOI, the classifier can also identify the specific defect type thereof. The classifier can be implemented as various types of machine learning models, such as, e.g., Linear classifiers, Support vector machines (SVM), neural networks, decision trees, etc., and the present disclosure is not limited by the specific model implemented therewith.

Referring to FIG. 5, there is illustrated a generalized flowchart of training a classifier usable for classifying a group of defect candidates resulting from defect inspection in accordance with certain embodiments of the presently disclosed subject matter.

Training data can be generated (502) (e.g., by the training module in processing circuitry 102) for training the classifier. Specifically, it can be verified (504) whether the plurality of defect classes of defect candidates (as resulting from block 308) each comprises a sufficient number of defect candidates. It can be further verified whether the defect classes are balanced with respect to each other (in terms of number of defect candidates). By way of example, the plurality of defect classes should have a substantially equivalent amount of defect candidates with respect to each other. For instance, in cases of two defect classes, DOI and nuisances, the two defect classes should each include more than a minimum number of candidates, and they should be balanced, e.g., they should have a similar number of defect candidates, so as to ensure the classifier to learn sufficient characteristics of each class.

In cases where a given defect class does not have sufficient defect candidates (either with respect to the minimum number of candidates, or with respect to other classes), synthetic defect candidates can be generated (506). There are various ways to generate synthetic defects. By way of example, one or more synthetic defect candidates can be created in the attribute space so as to be in proximity to the existing defect candidates in the same defect class. Attribute values of the synthetic defect candidates can be selected accordingly in order to fall into the same class while being close to the existing candidates. Once sufficient candidates are created for the given defect class, each synthetic defect candidate can be associated (508) with ground truth of the given defect class. The training data comprising the plurality of defect classes, each having a sufficient number of defect candidates (sufficient for training the classifier), can be used (510) to train the classifier.

The classifier, once being trained, can be used to classify the entire group of defect candidates in the original dataset (or in the normalized dataset). Each defect candidate in the group can be assigned with a defect class from the plurality of defect classes by the classifier. In cases where the dataset was partitioned into sub-spaces, as described above with refence to block 304, the normalization, clustering, and classification is performed per sub-space. In particular, a classifier can be trained and used for classification for each sub-space. The classified defect candidates from each sub-space can be combined and used as input for the decision model.

The defect class can be added as an attribute into the original dataset (or the normalized dataset), such as the first attribute described above with reference to block 202, indicative of defect classes of the group of defect candidates generated by the classifier. By way of example, the first attribute can be added as a column into a tabular dataset. The dataset with the added first attribute forms the training dataset as described above with reference to block 202, which is used to train the decision model.

As described above with reference to block 204, the decision model can be trained to learn a sorting rule pertaining to a series of attributes including the first attribute (i.e., the defect classes of the defect candidates generated by the classifier). The sorting rule is learnt in order to rank the group of defect candidates into a total order in accordance with the ground truth defect classes indicated by the second attribute. Total order indicates that each defect candidate is associated with a distinct ranking in the order. The series of attributes should be an optimal subset of attributes that is selected from all attributes in the dataset, such that sorting all defect candidates according to the subset of serialized attributes will result in a total order of candidates according to the sorting rule (e.g., ranking according to the probability to be DOI). There are various ways of learning the sorting rule. There is now described below a possible implementation.

By way of example, the training dataset can be firstly sorted in accordance with the first attribute (i.e., the defect classes of the defect candidates generated by the classifier). The sorting can be according to the number or percentage of DOIs included in each defect class. For instance, the tabular dataset can be split into multiple subsets, each corresponding to a respective defect class. The subset of defect candidates with a defect class that has the most DOIs (or largest percentage of DOIs) can be placed first in the table. The next subset of defect candidates with a defect class that has the second most DOIs can be placed next to the first subset. The remaining candidates can be arranged in a similar manner, according to a descending order of the DOIs in their defect classes, giving rise to a sorted dataset (e.g., a sorted table).

For each subset of defect candidates in the sorted table (e.g., a sub-table in the sorted table) that corresponds to a respective defect class, the decision model learns what attributes can be used to sort the subset of candidates sequentially so as to achieve an intra-subset order that is consistent with the ground truth defect classes of the candidates in the subset. For instance, for the first subset/sub-table that has the most DOIs in the sorted table, each candidate is associated with a second attribute indicative of its ground truth defect class provided by a review tool (it is to be noted that although only the subset of candidates that were previously reviewed by the review tool initially has the second attribute, the remaining candidates can be automatically assigned with an “unknown” value for the second attribute). The decision model learns that, among all the attributes (except for the first attribute that is already used in the first sorting, and the second attribute which is the ground truth), when sorting the sub-table using certain selected attributes in a specific order, the candidates that are listed on top are the ones having the ground truth defect classes as DOIs. In other words, the decision model learns how to select attributes and sort the sub-table according to the selected attributes, so as to have the candidates that are reviewed as real defects (DOIs) on top. The decision model can also learn to sort the candidates with the remaining classes in a specific order.

The decision model can learn to sort each of the multiple sub-tables in a similar manner, until all sub-tables are sorted, where the candidates that are reviewed as real defects are listed on top. The model can then learn to sort between sub-tables, such that all DOIs from all sub-tables will be listed on top, followed by other classes in a specific order.

In such ways the decision model can eventually learn a rule to sort all the candidates in the training dataset in a specific order, so as to be consistent with the ground truth defect classes thereof. The decision model trained as such, when deployed in runtime, can rank a given inspection dataset into a full order, where each defect candidate is associated with a distinct ranking representative of the likelihood of the defect candidate being a DOI, such as illustrated in table 704 in FIG. 7.

In some embodiments, the decision model can be implemented as various ML models that are capable of learning a sorting rule pertaining to a series of attributes to rank the group of defect candidates into a total order. In some cases, the implementation of the decision model can be regarded as a sorting optimization problem according to a predefined rule or objective.

Turning now to FIG. 6, there is illustrated a generalized flowchart of runtime defect examination on a semiconductor specimen using a trained ML based examination system in accordance with certain embodiments of the presently disclosed subject matter.

Once the training process of the ML based examination system as described with reference to FIGS. 2-5 is completed, the ML based examination system can be deployed in inference for runtime defect examination. In inference, the runtime examination system comprises the trained classifier and a trained decision model. Optionally, it can also include the data processing module as described above.

Specifically, an inspection dataset can be obtained (602) (e.g., by the data processing module 104 in processing circuitry 102). The inspection dataset is informative of a group of defect candidates and attributes thereof resulting from examining a semiconductor specimen by an inspection tool. Similar to the training dataset, the inspection dataset can be represented as a tabular dataset, as exemplified in FIG. 7. As the inspection dataset is acquired by an inspection tool in runtime examination, it has not been reviewed by a review tool, or classified by a classifier. Therefore, the inspection dataset does not include any attributes indicative of defect classes, nor the first attribute, or the second attribute as described above.

Optionally, in some cases, the inspection dataset can be normalized (606) (e.g., by the data processing module 104) prior to being further processed. The data normalization can be performed in a similar manner as described above with reference to block 306 of FIG. 3 and FIG. 4. The inspection dataset can be normalized by transforming values of each given attribute of at least some of the attributes into a specific distribution, and evaluating transformation error of the transformation, to determine whether to filter the given attribute from the inspection dataset. After data normalization, a normalized dataset is generated, including filtered attributes, each having normalized values.

Optionally, the inspection dataset can be partitioned (604) (e.g., by the data processing module 104) into a plurality of sub-spaces based on one or more attributes. The sub-spacing can be performed in a similar manner as described above with reference to block 304 of FIG. 3. In such cases, the normalization and the later processing, such as classifying, are respectively performed for each sub-space.

The group of defect candidates can be classified (608) by a classifier into a plurality of defect classes, such that each defect candidate is associated with a respective defect class. The classifier is previously trained as described in FIG. 5. The classifier is previously trained based on training data derived from a subset of defect candidates (of an original dataset) that is reviewed by a review tool and has an attribute (i.e., the second attribute described above) indicative of ground truth defect classes thereof. Specifically, the training data is derived by clustering the subset of defect candidates into a plurality of clusters based on values of inspection attributes of the defect candidates (the inspection attributes are from the original dataset as described above with respect to FIG. 3), and including at least the plurality of clusters of defect candidates in the training data.

In cases of sub-spacing as described with reference to block 604, the normalization and the classifying are respectively performed for each sub-space. The classified defect candidates from each sub-space can be combined and form a group of classified defect candidates as input to the decision model.

The group of defect candidates can be ranked (610) by a decision model into a total order using a sorting rule. Each defect candidate is associated with a distinct ranking in the total order representative of the likelihood of the defect candidate being a defect of interest (DOI). The decision model is previously trained to learn the sorting rule pertaining to the plurality of defect classes associated with the group of defect candidates and a series of attributes in the inspection data. The detailed training process of the decision model is described above and will not be repeated here for purposes of brevity of the description.

The output of the ranking is exemplified in table 704 of FIG. 7, where a new column “rank” is added to the tabular dataset, and each of the group of defect candidates is associated with its unique ranking in the total order.

In some cases, the ranking can be used to select, from the inspection data, a list of defect candidates to be reviewed by a review tool (such as, e.g., ADR). The list of defect candidates is selected in accordance with a review budget of the review tool based on the distinct ranking thereof. By way of example, if the review budget is 1000 candidates, the defect candidates that are ranked from 1 to 1000 in the total order can be selected to be reviewed by the review tool. The review tool is configured to capture review images (typically with higher resolution) at locations of the selected defect candidates, and review the review images for ascertaining whether a defect candidate is indeed a DOI. In such cases, the defect candidates that are most likely to be DOIs can be guaranteed to be reviewed, thus increasing detection sensitivity and capture rate.

In some cases, the ranking can be used to filter nuisances from the group of defect candidates according to their ranking in the order.

It is to be noted that examples illustrated in the present disclosure, such as, e.g., the exemplified ML models, the tabular dataset representation, the sorting processes, etc., are illustrated for exemplary purposes, and should not be regarded as limiting the present disclosure in any way. Other appropriate examples/implementations can be used in addition to, or in lieu of the above.

Among advantages of certain embodiments of the presently disclosed subject matter as described herein, is providing a defect ranking system that, given runtime inspection data of a large group of defect candidates (the order of magnitude of the number of defect candidates revealed by inspection may be between tens of thousands or millions), can rank the group of defect candidates into a total order, wherein each defect candidate is associated with a distinct ranking in the total order representative of the likelihood of the defect candidate being a DOI.

The ranking can be used to select a list of defect candidates to be reviewed by a review tool, meeting a review budget. The list selected as such includes the candidates that are most likely to be DOIs, thus ensuring that these probable candidates are properly reviewed by the review tool. This can increase detection capture rate and sensitivity. Additionally, or alternatively, the ranking can also be used to filter nuisances from the group of defect candidates.

Among further advantages of certain embodiments of the presently disclosed subject matter as described herein is that the inspection data can be normalized prior to be processed, e.g., via data transformation and filtration, which can standardize the data from different sources to be more robust/stable and comparable. The normalized data, when being used for later ML based processing, can improve the performance of the ML algorithms, such as their robustness, stability, recall, precision, miss rate, and accuracy. In addition, it is proven that data transformation and attribute filtration can increase DOI similarity, thus facilitating differentiating the DOIs from the remaining nuisance population.

Among further advantages of certain embodiments of the presently disclosed subject matter as described herein is clustering/re-classifying the subset of defect candidates (or a normalized subset) that was reviewed by a review tool into a plurality of clusters based on values of the inspection attributes of these candidates, and using the re-classified clusters of defect candidates as training data for the classifier. This can improve the classifier performance, as the defect classes provided by the review tool were based on review attributes, thus are not necessarily accurate in the inspection attribute space. Using the subset of defect candidates associated with such classes directly as training data to train a classifier for defect classification of defect candidates resulting from inspection tools, may possibly mislead the classifier to create separation planes that, when being used, may cause degradation of classification accuracy. The clustering/re-classifying can improve the training data quality, which in turn improves the classification performance of the trained classifier.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “classifying”, “ranking”, “sorting”, “selecting”, “normalizing”, “transforming”, “evaluating”, “partitioning”, “training”, “using”, “generating”, “clustering”, “including”, “performing”, “identifying”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the examination system, the defect examination system or defect ranking system, and respective parts thereof disclosed in the present application.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates, including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination” or its derivatives used in this specification, are not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results, such as measured images, are analyzed, for example, by employing image-processing techniques. Note that, unless specifically stated otherwise, the term “metrology” or derivatives thereof used in this specification, are not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as “false alarm” defect) which can be disregarded because it has no effect on the functionality of the completed device, and does not impact yield.

The term “defect candidate” used in this specification should be expansively construed to cover a suspected defect location on the specimen which is detected to have relatively high probability of being a defect of interest (DOI). Therefore, a defect candidate, upon being reviewed/tested, may actually be a DOI, or, in some other cases, it may be a nuisance as described above, or random noise that can be caused by different variations (e.g., process variation, color variation, mechanical and electrical variations, etc.) during inspection.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system for runtime defect examination on a semiconductor specimen, the system comprising a processing circuitry configured to:
obtain an inspection dataset informative of a group of defect candidates and attributes thereof resulting from examining the semiconductor specimen by an inspection tool;
classify, by a classifier, the group of defect candidates into a plurality of defect classes such that each defect candidate is associated with a respective defect class; and
rank, by a decision model, the group of defect candidates into a total order using a sorting rule, wherein each defect candidate is associated with a distinct ranking in the total order representative of the likelihood of the defect candidate being a defect of interest (DOI), wherein the decision model is previously trained to learn the sorting rule pertaining to the plurality of defect classes associated with the group of defect candidates and a series of attributes in the inspection data.

2. The computerized system according to claim 1, wherein the inspection dataset is represented as a tabular dataset.

3. The computerized system according to claim 1, wherein the processing circuitry is further configured to select, from the inspection dataset, a list of defect candidates to be reviewed by a review tool, the list of defect candidates selected in accordance with a review budget of the review tool based on the distinct ranking thereof.

4. The computerized system according to claim 1, wherein the processing circuitry is further configured to normalize the inspection dataset by transforming values of each given attribute of at least some of the attributes into a specific distribution, and evaluate transformation error of the transformation to determine whether to filter the given attribute from the inspection dataset, giving rise to a normalized dataset with filtered attributes each having normalized values.

5. The computerized system according to claim 4, wherein the processing circuitry is further configured to partition the inspection dataset into a plurality of sub-spaces based on one or more attributes, and perform the normalizing and classifying for each sub-space, and the processing circuitry is configured to rank classified defect candidates combined from the plurality of sub-spaces.

6. The computerized system according to claim 1, wherein the plurality of classes comprises DOIs, nuisances, unknown, and do not care (DNC).

7. The computerized system according to claim 1, wherein the classifier is previously trained based on training data derived from a subset of defect candidates that is reviewed by a review tool and has an attribute indicative of ground truth defect classes thereof.

8. The computerized system according to claim 7, wherein the training data is derived by clustering the subset of defect candidates into a plurality of clusters based on values of inspection attributes of the defect candidates, and including at least the plurality of clusters of defect candidates in the training data.

9. The computerized system according to claim 1, wherein the decision model is trained using a training dataset informative of a group of defect candidates and attributes thereof resulting from examining one or more semiconductor specimens by at least an inspection tool and a review tool, the attributes comprising a first attribute indicative of defect classes of the group of defect candidates generated by the classifier, the training dataset comprising a subset of defect candidates that is reviewed by the review tool and has a second attribute indicative of ground truth defect classes thereof.

10. The computerized system according to claim 9, wherein the decision model is trained by sorting the training dataset in accordance with the first attribute, giving rise to a sorted dataset comprising multiple subsets of defect candidates, each subset corresponding to a respective defect class of the first attribute; for each subset of defect candidates, identifying one or more attributes to be used for sorting the defect candidates within the subset so as to have a sorted subset of defect candidates in accordance with the ground truth defect classes thereof; and sorting between multiple sorted subsets to have all defect candidates in the training dataset to be sorted in accordance with the ground truth defect classes thereof.

11. A computerized method of training a machine-learning (ML) based examination system, the method comprising:
obtaining a training dataset informative of a group of defect candidates and attributes thereof resulting from examining one or more semiconductor specimens by at least an inspection tool and a review tool, the attributes comprising a first attribute indicative of defect classes of the group of defect candidates generated by a classifier, the classifier previously trained based on training data derived from a subset of defect candidates in the training dataset that is reviewed by the review tool and has a second attribute indicative of ground truth defect classes thereof; and
training a decision model using the training dataset, to learn a sorting rule pertaining to a series of attributes including the first attribute, the sorting rule usable for ranking the group of defect candidates into a total order in accordance with the ground truth defect classes indicated by the second attribute, where each defect candidate is associated with a distinct ranking in the total order representative of the likelihood of the defect candidate being a defect of interest (DOI).

12. The computerized method according to claim 11, wherein the training dataset is represented as a tabular dataset.

13. The computerized method according to claim 11, wherein the obtaining a training dataset comprises:
obtaining an original dataset informative of the group of defect candidates and attributes thereof resulting from examining the one or more semiconductor specimens by at least an inspection tool and a review tool, the original dataset including the subset of defect candidates that is reviewed by the review tool and has the second attribute indicative of ground truth defect classes thereof;
clustering the subset of defect candidates into a plurality of clusters based on values of the attributes thereof; and
classifying, using the classifier, the group of defect candidates into a plurality of defect classes, wherein the classifier is pre-trained using the training data including at least the plurality of clusters of defect candidates.

14. The computerized method according to claim 13, further comprising normalizing the original dataset comprising: transforming values of each given attribute of at least some of the attributes in the original dataset into a specific distribution, and evaluating transformation error of the transformation to determine whether to filter the given attribute from the original dataset, giving rise to a normalized dataset with filtered attributes each having normalized values, the normalized dataset including a normalized subset corresponding to the subset of defect candidates, and wherein the clustering is performed on the normalized subset based on the normalized values of the filtered attributes thereof.

15. The computerized method according to claim 14, further comprising partitioning the original dataset into a plurality of sub-spaces based on one or more attributes, and the normalizing, clustering, and classifying are performed for each sub-space.

16. The computerized method according to claim 13, wherein the training data is generated by verifying whether the plurality of defect classes each comprises a sufficient number of defect candidates, and whether the defect classes are balanced with respect to each other, and in cases where a given defect class does not have sufficient candidates, generating synthetic defect candidates for the given defect class, and associating each synthetic defect candidate with ground truth of the given class.

17. The computerized method according to claim 11, wherein the training comprises sorting the training dataset in accordance with the first attribute, giving rise to a sorted dataset comprising multiple subsets of defect candidates, each subset corresponding to a respective defect class of the first attribute; for each subset of defect candidates, identifying one or more attributes to be used for sorting the defect candidates within the subset so as to have a sorted subset of defect candidates in accordance with the ground truth defect classes thereof; and sorting between multiple sorted subsets to have all defect candidates in the training dataset to be sorted in accordance with the ground truth defect classes thereof.

18. The computerized system according to claim 11, wherein the plurality of defect classes comprises DOIs, nuisances, unknown, and do not care (DNC).

19. The computerized system according to claim 11, wherein the one or more semiconductor specimens comprise one or more layers of one or more semiconductor wafers.

20. A non-transitory computer readable storage medium tangibly embodying a program of instructions that, when executed by a computer, cause the computer to perform a method of defect examination on a semiconductor specimen, the method comprising:
obtaining an inspection dataset informative of a group of defect candidates and attributes thereof resulting from examining the semiconductor specimen by an inspection tool;
classifying, by a classifier, the group of defect candidates into a plurality of defect classes such that each defect candidate is associated with a respective defect class; and
ranking, by a decision model, the group of defect candidates into a total order using a sorting rule, wherein each defect candidate is associated with a distinct ranking in the total order representative of the likelihood of the defect candidate being a defect of interest (DOI), wherein the decision model is previously trained to learn the sorting rule pertaining to the plurality of defect classes associated with the group of defect candidates and a series of attributes in the inspection data.
